(19) United States
(12) Patent Application Publication
(10) Pub. No.: US 2012/0285946 A1
(43) Pub. Date: Nov. 15, 2012

(54) UTENSIL QUALITY FEEDBACK FOR INDUCTION COOKTOP

(75) Inventor: Daniel Vincent Brosnan, Louisville, KY (US)

(73) Assignee: GENERAL ELECTRIC COMPANY, Schenectady, NY (US)

(21) Appl. No.: 13/104,210

(22) Filed: May 10, 2011

(51) Int. Cl. H05B 6/12

(52) U.S. Cl. 219/621; 219/624

(57) ABSTRACT

Methodology, apparatus and computer programming are provide that permit an induction cooking appliance to evaluate a utensil for use with the appliance. A user may manually initiate an evaluation that will prompt the user to place a utensil on the appliance for evaluation. An evaluation is made based on differences between the expected energy and actual energy delivered. A score related to suitability for use of the utensil may then be displayed to the user.

### FIELD OF THE INVENTION

The present subject matter relates to induction cooktops. More particularly, the present subject matter relates to apparatus and methodologies for providing integral feedback testing of utensils for use with induction cooktops.

### BACKGROUND OF THE INVENTION

Cooking with a induction cooktop requires the use of ferromagnetic utensils, i.e., pans, in order to effectively capture the magnetic field produced by the induction cooking coil. So, for example aluminum pans will be very inefficient for cooking while cast iron would be a great candidate.

Often when customers purchase an induction cooktop they will need to purchase a new set of pans or attempt to use their existing pans without knowledge of how compatible they are. Additionally, there are many utensil suppliers that claim to be induction compatible but often their utensils turn out to be very inefficient.

U.S. Pat. No. 6,140,617, to Berkcan et al. entitled “Cooktop control and monitoring system including detecting properties of a utensil through a solid-surface cooktop” describes an induction cooktop with built in sensors to detect certain utensil properties including presence/absence, removal/placement, and size, but such detection is independent of the cooking utensil's composition.

U.S. Pat. No. 5,648,008 to Barritt et al. entitled “Inductive cooking range and cooktop” describes an induction cooking apparatus including a power inverter circuit and circuitry for compensating for variations in cookware materials.

U.S. Pat. No. 4,810,847 to Ito entitled “Load applicability detecting device for induction-heating cooking apparatus” describes an induction cooking appliance including a load applicability detecting device that is configured to compare the input current to an inverter to a reference during an initial startup period to provide a load applicability detection signal.

In view of these known concerns, it would be advantageous to provide an induction cooktop appliance with the capability to provide a quick check of the quality of utensils sought to be used with the appliance. Moreover, it would be particularly advantages if such capability could be provided without requiring any additional hardware beyond that normally present in an induction cooking appliance and to do so at minimal or no additional cost.

### BRIEF DESCRIPTION OF THE INVENTION

Aspects and advantages of the invention will be set forth in part in the following description, or may be obvious from the description, or may be learned through practice of the invention.

The present subject matter relates to a method for informing a user of the suitability for use of a utensil with an induction cooking appliance. Generally a utensil, in the present context, may correspond to any cooking item that may contain items to be heated. For example, pots and pans or other containers that may hold things to be heated or cooked. The method provides for positioning a utensil on a selected portion of the appliance, energizing the appliance, measuring energy delivered to the utensil, comparing the measured energy to reference energy values, and conveying an evaluation of the utensil to the user.

In selected embodiments, the method provides for positioning the utensil in alignment with a central portion of an induction heating coil associated with the appliance. In certain embodiments, the method further comprises determining the maximum energy able to be delivered to the utensil based on the energy at startup (the test mode) of the utensil and conveying an evaluation of differences between the reference energy and measured energy delivered to the utensil, possibly by way of a user readable display and sometimes by displaying a numeric usability score to the user.

In particular embodiments, the method provides for manually initiating evaluation of the utensil and prompting the user to place the utensil on the appliance. In selected particular embodiments, the method provides for measuring energy by measuring and conditioning a current feedback signal delivered to an induction heating coil associated with the appliance.

The present subject matter also relates to a computer program embodied on a computer readable medium for controlling an induction cooking appliance to evaluate a utensil for use with the appliance. In particular embodiments, the computer program includes code segments, that prompt a user to place a utensil on the cooking surface, that cause the appliance to be energized, that determine the amount of energy delivered to the utensil, that compare the measured energy to a reference energy table, and that cause an evaluation of the utensil to be conveyed to a user.

In more particular embodiments, the computer program further comprises a code segment that determines the estimated energy to be delivered to the utensil based on the energy at activation and a code segment that evaluates the utensil based on differences between the reference energy table and that determined amount of energy delivered to the utensil. In selected embodiments, the computer program further comprises a code segment that receives a user instruction to initiate evaluation of a utensil and a code segment that causes a user to be prompted to place the utensil on the appliance.

The present subject matter also relates to an induction cooking appliance including an induction heating coil, an inverter configured to supply energy to the coil, an energy monitoring element configured to monitor energy delivered from the inverter to the coil, a processor, and a display. In such embodiment the processor is configured to evaluate a utensil placed proximate the coil for suitability of use with the appliance by causing the appliance to be energized, determining the amount of energy delivered to the utensil, and causing the display to convey the evaluation to a user.

In other embodiments, the appliance further includes a memory. In such embodiments, the processor is further configured to obtain data from the memory regarding expected delivered energy, and to evaluate the utensil based on differences between the expected delivered energy and the determined energy delivered. In particular embodiments, the appliance further includes a manual operable switch configured for selective operation by an appliance user and the processor is further configured to accept an input based on operation of the switch to initiate evaluation of a utensil, and to cause a prompt to be displayed on the display to prompt the user to place a utensil on the appliance. In more particular embodiments, the energy monitoring element is a current feedback sensor and associated circuit conditioning.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic block diagram of a portion of an induction cooking appliance; and

FIG. 2 is a flow chart illustrating an exemplary operational methodology in accordance with the present subject matter.

Repeat use of reference characters throughout the present specification and appended drawings is intended to represent same or analogous features or elements of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As noted in the Summary section, the present subject matter is directed toward apparatus and methodologies for providing efficient feedback testing of utensils for use with induction cooktops.

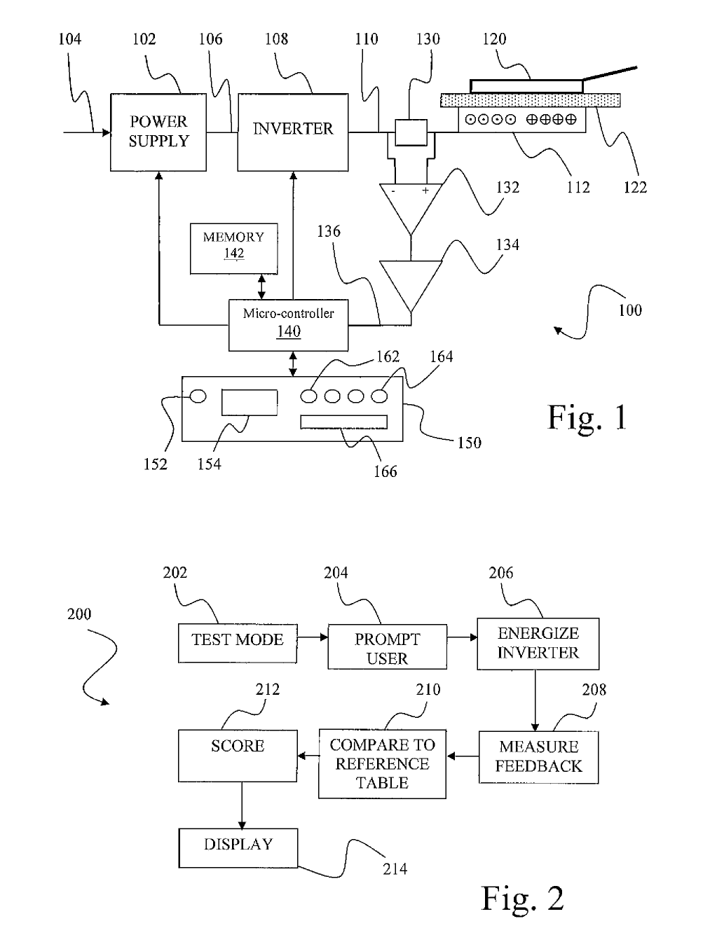

With reference now to FIG. 1, there is illustrated a schematic block diagram of a portion of an induction cooking appliance 100. Appliance 100 may include a power supply 102 configured to receive an alternating current (AC) input via input power line 104 from, for example, a residential source such as a home outlet. Power supply 102 may be configured to provide a direct current (DC) output voltage on output line 106 to supply operational power to a half bridge resonant power inverter 108. Inverter 108 is configured to supply operating power to induction cooking coil 112 by way of output line 110 from inverter 108. In an exemplary configuration, inverter 108 may operate as a high frequency, high current power source for coil 112. In an exemplary configuration, the operating frequency for inverter 108 by range from 20-50 KHz while the supplied current to coil 112 may typically range from 0-40 Amps RMS.

As will be understood by those of ordinary skill in the art, current through coil 112 creates a magnetic field that will be coupled into a cooking utensil 120 through, for example, a glass support surface 122 thereby creating eddy currents in utensil 120 that will heat the utensil. The amount of magnetic field that can be coupled into utensil 120 is most directly a function of the utensil's size/shape, placement relative to the coil, and material.

In accordance with present technology, induction cooking appliance 100 may be provided with features that can be utilized in testing a cooking utensil, for example, a cooking pan, for expected performance while in use with induction cooking appliance 100. These features may be provided using components, signals, and sub-systems that, in most instances, may already be present in the appliance.

For example, a feedback signal 136 that is representative of the current being delivered to coil 112, and thus also representative of the amount of power being delivered to utensil 120, may be provided via a resistive shunt current sensor 130 inline with the current path 110 from inverter 108 to coil 112. A voltage across current sensor 130 produced by current flow in line 110 may be applied to the inputs of differential amplifier 132 and be buffered by amplifier 134 in a feedback network before being sent via line 136 to micro-controller 140 for processing. It should be appreciated by those of ordinary skill in the art that other feedback signals may also be employed that give an indication of energy either directly or indirectly. For example, other methods of detecting energy may include, without limitation, temperature changes, locating proximity to system resonance, input power as well as output power, and even things like vibration in the utensil that give an indirect indication of energy.

Processing of the feedback signal from line 136 may be conducted using an algorithm that can indicate, for control purposes, information related to the cooking utensil 120 by examining the current feedback signal. Other methods may also be used to determine this information, for example, those described previously as disclosed in U.S. Pat. No. 6,140,617, but using the current feedback signal may be employed without adding other cooking utensil detecting equipment to the appliance.

The feedback signal from line 136 may be applied to an input of micro-controller 140 which may then use the signal data provided in conjunction for information stored in writeable memory 142 to provide an indication of the relative suitability of a particular cooking utensil (pan) for use with the induction cooking appliance. Those of ordinary skill I the art will appreciate that micro-controller 140 may also correspond to a micro-processor, a micro-computer, an application specific integrated circuit (ASIC) device, or any other suitable device capable of processing input signals and generating output signals suitable for controlling components of induction cooking appliance 100.

It will be notice that additional components illustrated in FIG. 1 include a panel 150 on which may be positioned a number of control elements 152, 162, 164 and a representative pair of display elements 154, 166. The exact number of such controls and display elements is not important to the present subject matter except that to note that such control elements and displays may be used with the present subject matter as well as with control functions and operations of induction cooking appliance 100 to control the appliance's normal cooking operations.

In this instance, switch 152 may correspond to an electro-mechanical push button or other switching device, for example, a capacitive sensitive touch switch or even a portion of a touch responsive display screen that may correspond to a changeable portion of a touch panel display/control device. Of significance to the present disclosure is that there is provided an element, exemplary illustrated as switch 152, that provides a user with the capability of initiating a testing mode of operation that will ultimately provide a user with an indication of usability of a particular cooking utensil with induction cooking appliance 100.

With reference now to FIG. 2, there is illustrated a flow chart 200 illustrating an exemplary operational methodology in accordance with the present subject matter. In accordance with present technology, a methodology of operation on an induction cooktop allows a user to place a cooking utensil, such as a pan, onto a cooktop burner and receive feedback as to how efficient or acceptable that utensil is for induction cooking purposes.

In an exemplary method, a user would initiate a test mode at step 202 and would then be prompted at step 204 to place a utensil to be tested on the cooktop in alignment with the center portion of coil 112 (FIG. 1). After the user places the utensil (pan) on the cooktop, the micro-controller will activate the inverter system at step 206 and receive feedback information at step 208 related to the utensil. This information will then be used to point to a memory location with a lookup table associated with or contained within writable memory 142 indicating a range of feedback levels at a specific power level from what would be considered very inefficient, i.e., low feedback value, to very efficient, i.e., high feedback value, given the difference between the referenced energy and measured energy. It should be appreciated that other criteria could be established including a simple pass/fall or a score, e g. based on a range of 1-10, etc.

The inverter is energized at step 206 to apply power to the utensil for a predetermined duration of time at a specific power level. These levels and time durations may be chosen so as not to produce any unnecessary strain on the inverter and/or coil should the utensil being tested fall outside expected properties.

The feedback network will capture the amount of power being delivered to the utensil at step 208 for the duration of the powering. The feedback will be compared at step 210 to the lookup table previously referenced to determine the “score” at step 212 of the utensil. The “score” may then be displayed at step 214 to the user by some suitable method, for example, by displaying a rating between “1” and “10” on display 154 (FIG. 1) or by some other suitable means conveying the “score” to the user. It should be appreciated that such information may be conveyed by any humanly perceivable means including, without limitation, visual as well as audible means. Such might even include delivering a message in a previously selected language instructing the user, for example, “Do not use this utensil with your cooktop,” or “This utensil is usable but will not provide efficient operation of your cooktop,” or some other appropriate message.

Use of the present technology provides clear communication with users so that the user will be able to operate the cooking appliance as efficiently as possible. Further, from a manufacturer's point of view, use of the present subject matter at least provides an opportunity for reducing the number of user service calls due to use of non-compatible utensils.

As previously noted, the present subject matter may be provided using existing induction cooking appliance hardware, thus an embodiment of the present invention can also be embodied in the form of computer program code stored in memory 142 (FIG. 1). Alternatively however, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to facilitate prediction and optimization of modeled devices and systems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for informing a user of the suitability for use of a utensil with an induction cooking appliance, comprising:
positioning the utensil on a selected portion of the appliance;
energizing the appliance;
measuring energy delivered to the utensil;
comparing the measured energy to a reference energy; and
conveying an evaluation of the utensil based at least in part on the measured energy to the user.

2. A method as in claim 1, wherein positioning comprises positioning the utensil in alignment with a central portion of an induction heating coil associated with the appliance.

3. A method as in claim 1, further comprising:
determining estimated energy to be delivered to the utensil based on differences between the measured and referenced energy,
wherein conveying an evaluation comprises conveying an evaluation of differences between the referenced energy and measured energy delivered to the utensil.

4. A method as in claim 1, wherein conveying comprises displaying an evaluation on a user readable display.

5. A method as in claim 1, wherein conveying comprises displaying a relative suitability evaluation.

6. A method as in claim 1, wherein conveying comprises displaying a numeric usability score to the user.

7. A method as in claim 1, further comprising:
manually initiating evaluation of the utensil; and
prompting the user to place the utensil on the appliance.

8. A method as in claim 1, wherein measuring energy comprises measuring a feedback signal delivered to an induction heating coil associated with the appliance.

9. A computer program embodied on a computer readable medium for controlling an induction cooking appliance to evaluate a utensil for use with the appliance, said computer program comprising: a code segment that causes; a code segment that causes the appliance to be energized; a code segment that determines the amount of energy delivered to the utensil; and a code segment that causes an evaluation of the utensil based at least in part on the amount of energy delivered to be conveyed to a user.

10. A computer program in accordance with claim 9 further comprising a code segment that determines the estimated energy to be delivered to the utensil based on the energy measured at activation; and a code segment that evaluates the utensil based on differences between the referenced energy and that determined amount of energy delivered to the utensil.

11. A computer program in accordance with claim 9 further comprising a code segment that receives a user instruction to initiate evaluation of a utensil; and a code segment that causes a user to be prompted to place the utensil on the appliance.

12. An induction cooking appliance, comprising:
an induction heating coil;
an inverter configured to supply energy to said coil;
an energy monitoring element configured to monitor energy delivered from said inverter to said coil;
a processor; and
a display,
wherein the processor is configured to evaluate a utensil placed proximate said coil for suitability of use with the appliance by causing the appliance to be energized, to determine the amount of energy delivered to the utensil, and to cause the display to convey an evaluation to a user based at least in part on the energy delivered.

13. An appliance as in claim 12, further comprising:
a memory,
wherein the processor is further configured to obtain data from said memory regarding expected delivered energy, and to evaluate the utensil based on differences between the referenced energy and the determined energy delivered.

14. An appliance as in claim 12, further comprising:
a manual operable switch configured for selective operation by an appliance user,
wherein the processor is further configured to accept an input based on operation of the switch to initiate evaluation of a utensil, and wherein the processor is configured to cause a prompt to be displayed on the display to prompt the user to place a utensil on the appliance.

15. An appliance as in claim 12, wherein said energy monitoring element is a current sensor.
